(19) United States
(12) Patent Application Publication
(10) Pub. No.: US 2018/0053202 A1
(43) Pub. Date: Feb. 22, 2018

(54) BEACON BASED CHECK-IN FOR HEALTH REWARDS PROGRAM

(71) Applicant: Humana Inc., Louisville, KY (US)

(72) Inventors: Stuart Slutzky, Deerfield, IL (US); Agustin Gonzalez, Chicago, IL (US)

(21) Appl. No.: 15/243,009

(22) Filed: Aug. 22, 2016

(51) Int. Cl. G06Q 30/02; G06Q 50/22; G06F 19/00

(52) U.S. Cl. CPC G06Q 30/0226; G06F 19/328; G06Q 50/22

(57) ABSTRACT

A beacon based check-in system and method for a health rewards program. The present invention allows members to check-in to predetermined locations or events to earn points and rewards for use in health rewards programs. The member may use the points or rewards to purchase gift cards, merchandise or health related services.

### BACKGROUND OF THE INVENTIVE FIELD

The present invention is directed to a beacon based check-in system and method for a health rewards program. The present invention allows members to check-in to predetermined locations or events to earn points and rewards for use in health rewards programs. The member may use the points or rewards to purchase gift cards, merchandise or health related services.

Health insurance companies often provide wellness and rewards programs to incentivize their members to maintain healthy lifestyles. These programs benefit members and insurers by lowering health care costs for insured members. These health rewards programs are designed to reward members for making healthier choices (e.g., exercise and diet) and achieving personal health goals. These programs reward members by providing them points that can be used to redeem gifts or rewards such as gift cards from retailers, health products, or travel perks such as flights or hotel stays.

### SUMMARY OF THE GENERAL INVENTIVE CONCEPT

The present invention relates to a beacon based check-in system for tracking member attendance at healthy locations or events such as gyms, health clubs, health food stores, and blood bank drives. The electronic system uses wireless radio frequency beacons to automatically track member attendance at health events or member participation in healthy activities. The present invention automatically tracks member attendance and participation in real-time and provides reward points to members that can be tracked and updated via a member's mobile application.

The present invention is designed to incentivize people to lead healthier lives by providing rewards to members who attend the gym or other health related events. The system may be implemented by a health insurance company in partnership with a retail health club or other retail partners.

In one embodiment of the invention, the system is comprised of: a beacon-based check-in and rewards system for incentivizing people to maintain healthy lifestyles by awarding rewards to a member user comprising: a mobile application; a beacon placed at a predetermined location; the beacon comprised of a processing system and storage configured with a beacon identifier and adapted to store an event identifier; the processing system of the beacon programmed with one or more software routines to: 1) wirelessly transmit the beacon identifier and event identifier to the mobile application of the user; 2) receive programming input for editing the event identifier stored in the beacon based on event type; a remote processing system located remotely from the beacon; the remote processing system programmed with one or more software routines executing on the remote processing system to: 1) receive the beacon identifier, the event identifier, and user identifier transmitted from the mobile application; 2) determine the amount of health rewards to award the user based on the received beacon identifier, the event identifier, and user identifier; 3) transmit the amount of health rewards to the mobile application; wherein the mobile application is programmed with one or more software routines executing on the mobile application to: 1) receive the beacon identifier and the event identifier from the beacon; 2) transmit the beacon identifier, the event identifier, the user identifier, and a time and date stamp to the remote processing system; 3) receive the amount of health rewards from the mobile application; 4) store the amount of health rewards earned by the user for a current period of time; 5) provide the amount of health rewards earned by the user for the current period of time to the user.

The foregoing and other features and advantages of the present invention will be apparent from the following more detailed description of the particular embodiments, as illustrated in the accompanying drawings.

### BRIEF DESCRIPTION OF THE DRAWINGS

In addition to the features mentioned above, other aspects of the present invention will be readily apparent from the following descriptions of the drawings and exemplary embodiments, wherein like reference numerals across the several views refer to identical or equivalent features, and wherein:

FIG. 1 illustrates one embodiment of a beacon with a user in proximity to the beacon having a mobile application of the present invention;

FIG. 2 illustrates one embodiment of a calendar view of the present invention from the mobile application illustrating a registered check-in badge for the user;

FIG. 3 illustrates a close-up view of the check-in badge of FIG. 1;

FIG. 4 illustrates one embodiment of the transmission flow of data for the present invention;

FIG. 5 illustrates a detailed flow diagram of one embodiment of the present invention;

FIG. 6 illustrates one embodiment of the “points earned” page of the mobile application of the present invention; and

FIG. 7 illustrates one embodiment of the “force check-in” page of the mobile application of the present invention.

### DETAILED DESCRIPTION OF EXEMPLARY EMBODIMENT(S)

The following detailed description of the example embodiments refers to the accompanying figures that form a part thereof. The detailed description provides explanations by way of exemplary embodiments. It is to be understood that other embodiments may be used having mechanical and electrical changes that incorporate the scope of the present invention without departing from the spirit of the invention.

A beacon is a device which utilizes wireless (e.g., Bluetooth) low energy proximity sensing to wirelessly broadcast or receive small and static pieces of data within short distances. Coupled with an application (“app”), the beacon provides location-based action on the device such as a check-in. In one embodiment, the beacon is comprised of a processing system configured with a stored beacon identifier and a storage for storing other data such as an event identifier for transmission to a mobile application device of a member. The beacon can also be comprised of an accelerometer having motion detection features. The beacon is powered by a battery that can supply power to the beacon for approximately two years. The beacon can be adapted to transmit data via Bluetooth, Wi-Fi, or other known data transmission protocols. The beacon can be programmed with different event identifiers depending on the type of event or location the beacon is used with.

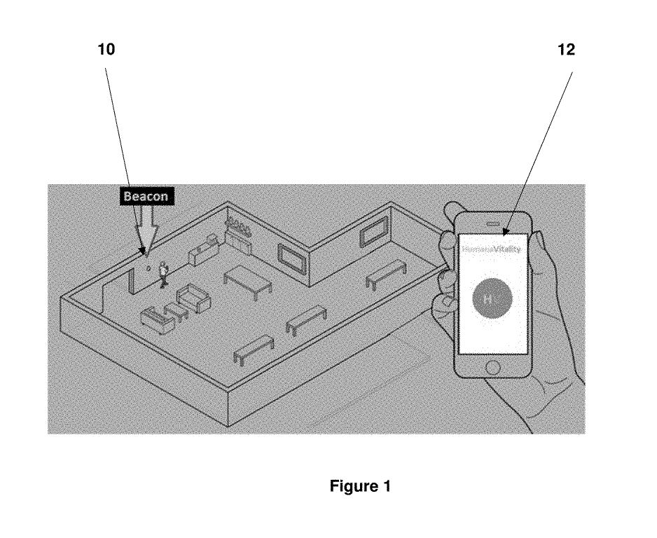

FIG. 1 illustrates one embodiment of a beacon 10 with a user in proximity to the beacon having a mobile application 12 of the present invention. To check in, a user will open the mobile beacon application (“app”), while in range of the beacon (depending on the environment up to 50 ft. away). To check-in with the beacon a member/user should:
walk in range of the beacon;
activate the beacon check-in feature, located in the mobile app;
activate and allow notifications to be displayed on the device;
wait for the success message;
verify the check-in on the main page (successful check-ins will be illuminated).

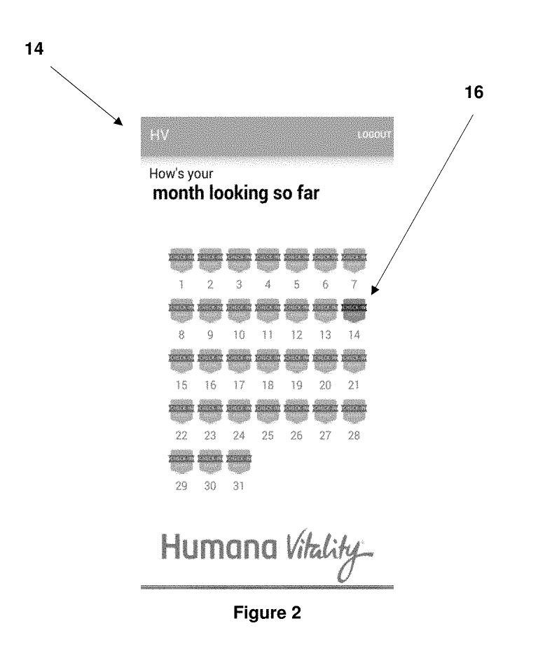

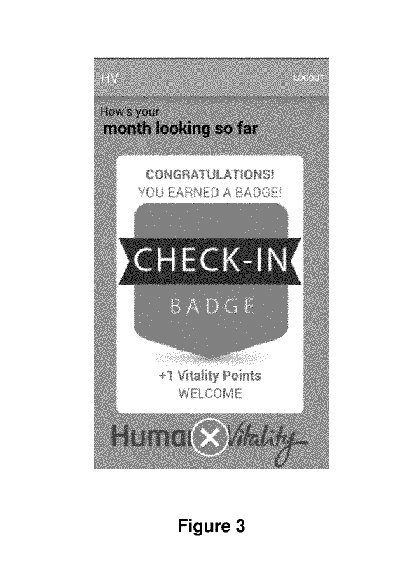

FIG. 2 illustrates one embodiment of a calendar 14 view of the present invention from the mobile application illustrating a registered check-in badge 16 for the user. FIG. 3 illustrates a close-up view of the check-in badge of FIG. 1.

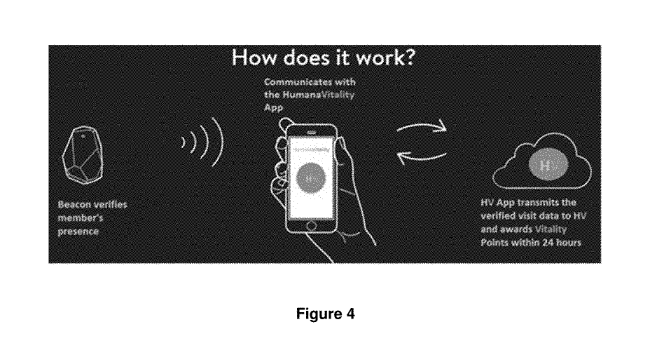

In one embodiment of the invention, the system is comprised of: a beacon-based check-in and rewards system for incentivizing people to maintain healthy lifestyles by awarding rewards to a member user, comprising: a mobile application; a beacon placed at a predetermined location; the beacon comprised of a processing system and storage configured with a beacon identifier and adapted to store an event identifier; the processing system of the beacon programmed with one or more software routines to: 1) wirelessly transmit the beacon identifier and event identifier to the mobile application of the user; 2) receive programming input for editing the event identifier stored in the beacon based on event type; a remote processing system located remotely from the beacon; the remote processing system programmed with one or more software routines executing on the remote processing system to: 1) receive the beacon identifier, the event identifier, and user identifier transmitted from the mobile application; 2) determine the amount of health rewards to award the user based on the received beacon identifier, the event identifier, and user identifier; 3) transmit the amount of health rewards to the mobile application; wherein the mobile application is programmed with one or more software routines executing on the mobile application to: 1) receive the beacon identifier and the event identifier from the beacon; 2) transmit the beacon identifier, the event identifier, the user identifier, and a time and date stamp to the remote processing system; 3) receive the amount of health rewards earned; 4) store the amount of health rewards earned by the user for a current period of time (e.g., week); and 5) provide the amount of health rewards earned by the user for the current period of time to the user. FIG. 4 illustrates the transmission flow of data for the present invention. Humana Vitality (“HV”) is the branded name of the health rewards program of the shown embodiment and as described in further detail herein.

In one embodiment, the present invention uses beacon identification numbers and event or location identification numbers to track member attendance at different events/locations and to reward points. There are two identifiers that the present invention uses to uniquely categorize the beacon across the system. The first identifier is the beacon identifier (e.g., MAC address or the serial number assigned to the beacon). The second identifier is the event identifier which is stored in a data field of the beacon storage (e.g., this identifier is the “minor” field). Changing the “minor” from 1-20 allows the system to map the appropriate pneumonic for the “event”. For example, minor 1=partner health club workout, which is tied to pneumonic “hcwp”; minor 2=flushot, which is tied to pneumonic “fsht”; minor 3=blood donation, which is tied to pneumonic “blud”. The major field can be used to store an alternative beacon identifier to be tracked by the system in case the serial number of the beacon changes at some point during beacon use. The “major” and “minor” fields provide the capability to alter the functionality of the beacon at will.

In this embodiment, once the beacon verifies a member's presence, the information is captured by the user's smartphone, or mobile app, which then appends the following information: member's entity identification (unique identifier); member's HADS identification (e.g., identifier in the HADS system, which is then reconciled and tied to the entity identification); time and date stamp; beacon identification (e.g., MAC address); and beacon major and minor event identifier for transmission to the remote processing system for verification and reward processing as previously discussed. Once all of the information is processed, the member is rewarded with health rewards (e.g., points). In one embodiment, the health rewards are applied to the member's mobile application within 20 mins from being verified by the beacon.

The major and minor fields are static, however, they can be edited. For example, a beacon used as a fitness beacon (minor=1) may be altered to capture flu shot attendance or another event at will (minor=2 or any other minor event identifier associated with the event). Both fields are transmitted from the beacon to the mobile application of the user. This information is forwarded to the remote rewards processing system of the present invention (e.g., Evidation/HADS/CORE).

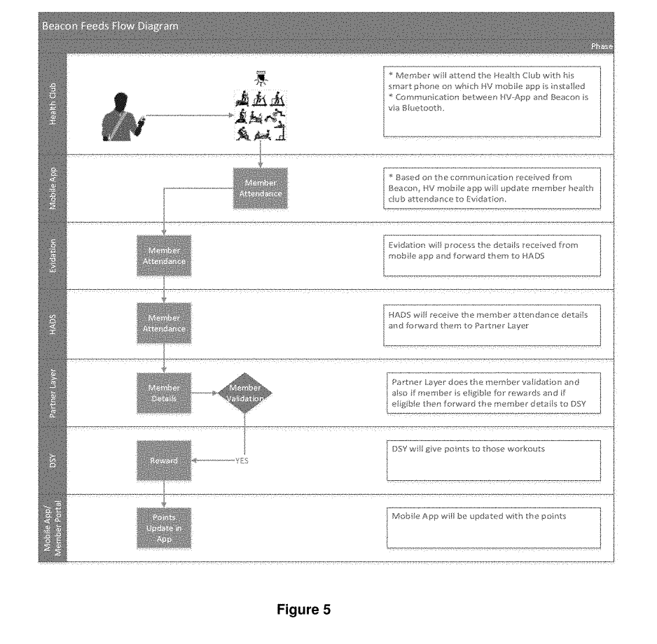

FIG. 5 illustrates a detailed flow diagram of one embodiment of the present invention in the context of a health club check-in process. The process starts when the user enters a health club location where a beacon of the present invention is located. Communication is established between the mobile app and the beacon via wireless transmission. Information, as previously discussed, is transmitted to a third party aggregator that provides a common interface to interact with multiple device providers (e.g., serves as a pass-through for the information flow). The third party aggregator will then forward the information to the HADS server which then forwards the system to the Partner Layer. The HADS system is also an aggregator, but with the ability to reconcile data from the first data aggregator and with other devices. The HADS server is responsible for housing all of the device data and forwarding it to other relevant systems. HADS also maintains the association between devices and members. The Partner Layer functions to perform member validation and eligibility for health rewards. The Partner Layer system contains the processing logic for awarding the points and submits the information to the Core DSY system for further processing. The Core system then applies the rewards to the members. The Core system is also responsible for event categorization. The reward information is then transmitted to the mobile app of the user. It is appreciated that in another embodiment, the functions of the third party aggregator, HADS, and CORE systems can be combined into one unified processing system or server.

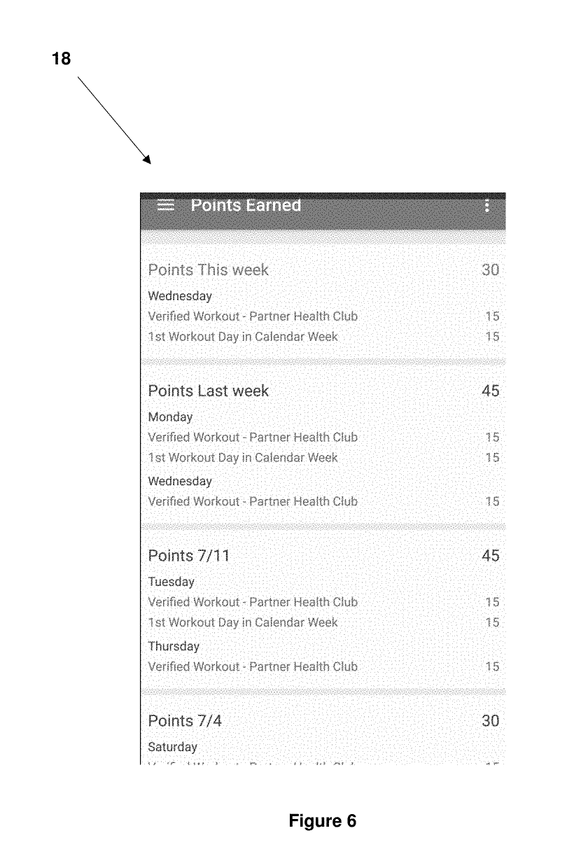

FIG. 6 illustrates one embodiment of the “points earned” page 18 of the mobile application of the present invention. In this embodiment, the mobile application awards 15 beacon or health points per visit; 15 bonus points for the first visit of the week; and 40 bonus points for 5 workouts in a week.

In another embodiment of the invention, the present invention can be used to track the duration of a member's visit at a predetermined event or location and to award points accordingly. In this embodiment, the member can check-in to the beacon when the member arrives at the beacon location and then check-out (using the same process as the check-in procedure) when leaving the beacon location. The remoted processing system receives the date and time stamp sent from the mobile app of the member for both the initial check-in and the subsequent check-out to determine the duration of the visit and award points based on the calculated duration.

In one embodiment, a beacon management tool allows a view of all of the beacons across the nation or any other geographic region, at any given time. When a member utilizes any of the beacons in the system network, the beacon and/or major identifier is captured and sent to the beacon management tool (along with being transmitted through all of the system) to provide the status of the beacon. The beacon management tool categorizes the beacon into the following status: active—pinged within a 24-hour period; alert—no ping within a 24-hour period; inactive—no ping within a 72-hour period. In addition to the status, the fleet management tool also provides the capability to view all current users across the beacon fleet.

In one embodiment, the major and minor fields within the beacon may be edited via a cloud management tool, or a mobile app provisioned to allow programming of the beacons. For example, the major field can house an identifier from 1-65,999. The same applies for the minor, where each number can be assigned to a particular event or location.

Any new event can be added by updating database (DB) tables on the Partner Layer side and mobile API side. The type of the event submission will be determined by event identifier (e.g., “category_id”) of the beacon device that will be stored in minor version field of the device and sent to the Partner Layer via the mobile app, Evidation and HADS as a value of the identifier “category_id”.

For example, the system will allow submitting the following events by beacon check-ins:

Workouts (HCWP)

Blood donation (BLUD)

Flu shot (FSHT)

In this embodiment, a table is created on the Partner Layer side for storing the mapping between received category_id in the check-in data and the event mnemonic. The table is populated with the following values (category_id is the unique value in the table, starts with [symbol] ):

| category_id | event_mnemonic |
|---|---|
| [symbol] | HCWP |
| [symbol] | BLUD |
| [symbol] | FSHT |

When the category_id value is received in the check in data, the event_mnemonic from this table is used to submit the event to the Core server. When category_id is not provided, or the value provided was not found in the table, the event mnemonic for category_id= [symbol] is use to submit the event to Core (default event mnemonic).

For this embodiment, the following category_id values are used to set up the usage of the beacon device:

| category_id (minor version) | Usage of the Beacon device |
|---|---|
| [symbol] | Workouts check-in |
| [symbol] | Blood donation check-in |
| [symbol] | Flu shots check-in |

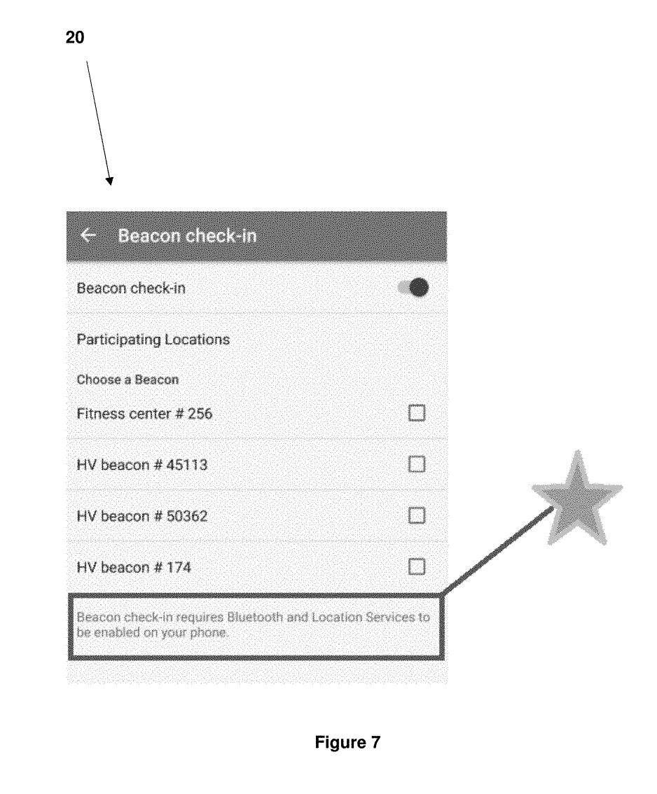

FIG. 7 illustrates one embodiment of the “force check-in” page 20 of the mobile application of the present invention. The beacon check-in screen can be configured to allow members to “force” the check-in. This feature may be used to alleviate the following issues:
“I swiped away the beacon message”
“I did not receive the beacon message”
“I cannot receive the message” (caused by shutting off notifications/Bluetooth or location services, or various other circumstances).

The present invention may also be used for environment mapping. For example, the beacons may be used to map an environment with the aim of guiding a member to select location within a retail environment. For example, the beacons can provide information guiding members to the precise location of healthy food/wellness type products.

The present invention may also be used to deploy beacons within a retail environment to actuate promotional messaging or to transmit member specific messages when a partner location is visited. For example, when a partner gym is visited the beacon will transmit a health related message on how to lower a risk assessed by a health program instituted by the system administrator or the beacon can transmit a workout plan to the member.

The present invention may also be configured with the ability to update beacon settings when a member walks in range of select devices. The present invention can also be configured with external peripherals such as a speaker or sign to allow the members to interact with the health program through different experiences and messages or programs.

While certain embodiments of the present invention are described in detail above, the scope of the invention is not to be considered limited by such disclosure, and modifications are possible without departing from the spirit of the invention as evidenced by the following claims:

What is claimed is:

1. A beacon-based check-in and rewards system for incentivizing people to maintain healthy lifestyles by awarding rewards to a mobile application of a member user, comprising:
a beacon placed at a predetermined location, the beacon comprised of a processing system and storage configured with a beacon identifier and adapted to store an event identifier, the processing system of the beacon programmed with one or more software routines to: 1) wirelessly transmit the beacon identifier and event identifier to the mobile application of the user; 2) receive programming input for editing the event identifier stored in the beacon based on event type;
a remote processing system, located remotely from the beacon, the remote processing system programmed with one or more software routines executing on the remote processing system to: 1) receive the beacon identifier, the event identifier, a user identifier transmitted from the mobile application; 2) determine the amount of health rewards to award the user based on the received beacon identifier, the event identifier, and user identifier; 3) transmit the amount of health rewards to the mobile application.

2. The system of claim 1, wherein the event identifier identifies the event of attending a gym location.

3. The system of claim 1, wherein the event identifier identifies a blood drive event.

4. The system of claim 1, further comprising:
a mobile application, the mobile application programmed with one or more software routines executing on the mobile application to: 1) receive the beacon identifier and the event identifier from the beacon; 2) transmit the beacon identifier, the event identifier, the user identifier, and a time and date stamp to the remote processing system; 3) receive the amount of health rewards earned; 4) generate an electronic calendar displaying registered check-ins for the user for each day the user registers a check-in; 5) store the amount of health rewards earned by the user for a current period of time; 6) provide the amount of health rewards earned by the user for the current period of time and the type of event related to the earned health rewards to the user.

5. The system of claim 1, further comprising:
a plurality of beacons located at predetermined locations;
a beacon management application, the beacon management application programmed with one or more software routines to: 1) receive beacon identifiers for the plurality of beacons from the remote processing system when the plurality of beacons are pinged; 2) track the status of all beacons; 3) provide a status update of the plurality of beacons providing information on which beacons have been pinged in a predetermined time period, and which beacons have been inactive for a predetermined time period.

6. The system of claim 4, wherein the mobile application is programmed with one or more software routines executing on the mobile application to allow the user to force a check-in to an event or location if the system does not automatically check the user in.

7. The system of claim 4, wherein the mobile application is programmed with one or more software routines executing on the mobile application to redeem health rewards of the user to purchase gift cards, food, merchandise or services.

8. A beacon-based check-in and rewards system for incentivizing people to maintain healthy lifestyles by awarding rewards to a member user, comprising:
a mobile application;
a beacon placed at a predetermined location, the beacon comprised of a processing system and storage configured with a beacon identifier and adapted to store an event identifier, the processing system of the beacon programmed with one or more software routines to: 1) wirelessly transmit the beacon identifier and event identifier to the mobile application of the user; 2) receive programming input for editing the event identifier stored in the beacon based on event type;
a remote processing system, located remotely from the beacon, the remote processing system programmed with one or more software routines executing on the remote processing system to: 1) receive the beacon identifier, the event identifier, and user identifier transmitted from the mobile application; 2) determine the amount of health rewards to award the user based on the received beacon identifier, the event identifier, and user identifier; 3) transmit the amount of health rewards to the mobile application;
wherein the mobile application is programmed with one or more software routines executing on the mobile application to: 1) receive the beacon identifier and the event identifier from the beacon; 2) transmit the beacon identifier, the event identifier, and the user identifier to the remote processing system; 3) receive the amount of health rewards earned; 4) store the amount of health rewards earned by the user for a current period of time; 5) provide the amount of health rewards earned by the user for the current period of time to the user.

9. The system of claim 8, wherein the mobile application is programmed with one or more software routines executing on the mobile application to generate an electronic calendar displaying registered check-in badges for the user for each day the user registers a check-in.

10. The system of claim 8, wherein the event identifier identifies the event of attending a gym location.

11. The system of claim 8, further comprising:
a plurality of beacons located at predetermined locations;
a beacon management application, the beacon management application programmed with one or more software routines to: 1) receive beacon identifiers for the plurality of beacons from the remote processing system when the plurality of beacons are pinged; 2) track the status of the plurality of beacons; 3) provide a status update of the plurality of beacons providing information on which beacons have been pinged in a predetermined time period and which beacons have been inactive for a predetermined time period.

12. The system of claim 8, wherein the mobile application is programmed with one or more software routines executing on the mobile application to allow the user to force a check-in to an event or location if the system does not automatically check the user in.

13. The system of claim 8, wherein the mobile application is programmed with one or more software routines executing on the mobile application to redeem health rewards of the user to purchase gift cards, food, merchandise or services.

14. A beacon-based check-in and rewards system for incentivizing people to maintain healthy lifestyles by awarding rewards to a member user, comprising:
a mobile application;
a beacon placed at a predetermined location, the beacon comprised of a processing system and storage configured with a beacon identifier and adapted to store an event identifier, the processing system of the beacon programmed with one or more software routines to: 1) wirelessly transmit the beacon identifier and event identifier to the mobile application of the user; 2) receive programming input for editing the event identifier stored in the beacon based on event type;
a remote processing system, located remotely from the beacon, the remote processing system programmed with one or more software routines executing on the remote processing system to: 1) receive the beacon identifier, the event identifier, and user identifier transmitted from the mobile application; 2) determine the amount of health rewards to award the user based on the received beacon identifier, the event identifier, and user identifier; 3) transmit the amount of health rewards to the mobile application;
wherein the mobile application is programmed with one or more software routines executing on the mobile application to: 1) receive the beacon identifier and the event identifier from the beacon; 2) transmit the beacon identifier, the event identifier, and the user identifier to the remote processing system; 3) receive the amount of health rewards earned; 4) store the amount of health rewards earned by the user for a current period of time; 5) provide the amount of health rewards earned by the user for the current period of time and the type of event related to the earned health rewards to the user; 6) redeem health rewards of the user to purchase gift cards, food, merchandise or services.

15. The system of claim 14 wherein the health rewards are health points.

16. The system of claim 14, further comprising:
a plurality of beacons located at predetermined locations;
a beacon management application, the beacon management application programmed with one or more software routines to: 1) receive beacon identifiers for the plurality of beacons from the remote processing system when the plurality of beacons are pinged; 2) track the status of the plurality of beacons; 3) provide a status update of the plurality of beacons providing information on which beacons have been pinged in a predetermined time period and which beacons have been inactive for a predetermined time period.

17. The system of claim 14, wherein the mobile application is programmed with one or more software routines executing on the mobile application to allow the user to force a check-in to an event or location if the system does not automatically check the user in.

18. The system of claim 14, wherein the mobile application is programmed with one or more software routines executing on the mobile application to: 1) transmit the time the user checked-in to the event associated with the event identifier and the time the user checked-out of the event associated with the event identifier; and
wherein the remote processing system is programmed with one or more software routines executing on the remote processing system to: 1) receive the time the user checked-in to the event associated with the event identifier and the time the user checked-out of the event associated with the event identifier; 2) determine the duration of time the user was at the event; 3) determine the amount of health rewards to award the user based on the duration of time.

19. The system of claim 1, further comprised of a mobile application wherein the mobile application is programmed with one or more software routines executing on the mobile application to: 1) transmit the date and time the user checked-in to the event associated with the event identifier and the date and time the user checked-out of the event associated with the event identifier; and
wherein the remote processing system is programmed with one or more software routines executing on the remote processing system to: 1) receive the time the user checked-in to the event associated with the event identifier and the time the user checked-out of the event associated with the event identifier; 2) determine the duration of time the user was at the event; 3) determine the amount of health rewards to award the user based on the duration of time.

20. The system of claim 8, wherein the mobile application is programmed with one or more software routines executing on the mobile application to: 1) transmit the time the user checked-in to the event associated with the event identifier and the time the user checked-out of the event associated with the event identifier; and
wherein the remote processing system is programmed with one or more software routines executing on the remote processing system to: 1) receive the time the user checked-in to the event associated with the event identifier and the time the user checked-out of the event associated with the event identifier; 2) determine the duration of time the user was at the event; 3) determine the amount of health rewards to award the user based on the duration of time.

21. The system of claim 1, wherein the processing system of the beacon is programmed with one or more software routines to: transmit a health related message to the mobile application.

22. The system of claim 8, wherein the processing system of the beacon is programmed with one or more software routines to: transmit a health related message to the mobile application.

23. The system of claim 14, wherein the processing system of the beacon is programmed with one or more software routines to: transmit a health related message to the mobile application.
